(19) United States
(12) Patent Application Publication
(10) Pub. No.: US 2026/0169131 A1
(43) Pub. Date: Jun. 18, 2026

(54) GLASS COVER FOR TWO DIFFERENT OPTICAL SENSORS

(71) Applicant: AGC GLASS EUROPE, Louvain-la-Neuve (BE)

(72) Inventors: Jean MASSON, Gosselies (BE); Alexandre COSTE, Gosselies (BE)

(73) Assignee: AGC GLASS EUROPE, Louvain-la-Neuve (BE)

(21) Appl. No.: 19/123,703

(22) PCT Filed: Nov. 27, 2023
(86) PCT No.: PCT/EP2023/083227

§ 371 Date: Apr. 23, 2025

(30) Foreign Application Priority Data
Dec. 16, 2022 (EP) 22214078.2

(51) Int. Cl. G01S 7/481

(52) U.S. Cl. CPC G01S 7/4813

(57) ABSTRACT

A cover for a vehicle sensor module which has at least two different optical sensors operating at different wavelength ranges. The cover has at least a first glass sheet with an absorption coefficient less than 15 m−1 at the first optical sensor's operating wavelength range. The cover also has two distinct zones corresponding to projections of the first and second optical sensors' field of view on the cover, respectively. The first zone is transparent at the first optical sensor's operating wavelength range and the second zone is transparent at the second optical sensor's operating wavelength range.

### FIELD OF THE INVENTION

The present invention relates to the field of sensor covers, more specifically to glass covers adapted for two different optical sensors.

### BACKGROUND OF THE INVENTION

Trend nowadays is to equip vehicles with increasing number of sensors. There is an increasing request from vehicle manufacturer to combine such sensors, meaning to integrate at least two different sensors into one single housing, such as the combination of a radar and a lidar, of a lidar and a camera, of a lidar and an infrared camera, . . . While these sensors are becoming more and more important, especially for partly-of fully-automated driving, the tendency is to hide such sensors for aesthetical pur-pose. Even if such sensor may be placed on the bodywork of the vehicle, meaning the sensor pops out from the vehicle, such incorporation is not seen as aesthetical for vehicle manufacturer. The tendency is to incorporate such sensors within the bodywork of vehicles, such as behind a window (as described in WO2018178284) or behind an external trim element (as described in WO2018178286) of the vehicle.

However combining sensors, each working at a specific wavelength range, means that the single cover in front of both sensors must be compatible for both optical sensors. There is therefore a need for a cover which would be compatible with optical sensors working at different wavelength ranges.

### SUMMARY OF THE INVENTION

The present invention concerns a cover for a vehicle sensor module. The vehicle sensor module comprises at least two different optical sensors, wherein a first optical sensor having a first field of view operates in the near-infrared wavelength range and a second optical sensor having a second field of view operates in the visible wavelength range. The cover comprises at least a first glass sheet having an absorption coefficient less than 15 m⁻¹ at the operating wavelength range of the first optical sensor, the at least first glass sheet comprising an internal face facing the at least two different optical sensors and an external face opposite to the internal face. The cover further comprises a first zone corresponding at least to a projection of the first field of view on the cover, and a second zone, distinctive from the first zone, corresponding at least to a projection of the second field of view on the cover. The first zone is transparent at the operating wavelength range of the first optical sensor and the second zone is transparent at the operating wavelength range of the second optical sensor.

### BRIEF DESCRIPTION OF THE DRAWINGS

The invention will now be described further, byway of examples, with reference to the accompanying drawings, wherein like reference numerals refer to like elements in the various figures. These examples are provided by way of illustration and not of limitation. The drawings are a schematic representation and not true to scale. The different elements of the drawings are shown separated in order to ease the compre-hension. The drawings do not restrict the invention in any way. More advantages will be explained with examples.

FIG. 1 shows the main elements to be used in the description.

FIG. 2a-d show alternative embodiment of the present invention, using ink.

FIG. 3 shows another alternative embodiment of the present invention, also using ink.

FIG. 4 shows another alternative embodiment of the present invention, using a film.

FIG. 5 shows another alternative embodiment of the present invention, using a interlayer with an insert.

FIG. 6 shows another alternative embodiment of the present invention, using a film with an insert.

FIG. 7 shows another alternative embodiment of the present invention, using a film with an ink.

### DETAILED DESCRIPTION OF ILLUSTRATIVE EMBODIMENTS

The present invention will be described with respect to particular embodiments and with reference to certain drawings but the invention is not limited thereto but only by the claims.

While some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

The present invention proposes a cover for a vehicle sensor module. A vehicle includes car, van, lorry, motorbike, bus, tram, train, drone, airplane, helicopter and the like.

The vehicle sensor module comprises at least two different optical sensors. The first optical sensor has a first field of view. The first optical sensor operates in the near-infrared wavelength range. A near-infrared sensor is a sensor whose operating wavelength range is situated in the near-infrared wavelength range, meaning between 780 nm and 1650 nm. It encompasses lidar and near-infrared cameras. Lidar is an ac-ronym for “light detection and ranging”. It is sometimes called “laser scanning” or “3D scanning”. The technology uses laser beams to create a 3D-representation of the sur-veyed environment. Operating wavelength of lidar compatible with the present invention is comprised between 780 nm and 1650 nm (usually referred to as near-infrared). More specifically, known operating wavelengths of currently produced lidars compatible with the present invention are 850 nm, 905 nm, 940 nm, 1064 nm, 1310 nm, 1350 nm, 1550 nm, 1650 nm. An acceptable variance of 25 nm around the nominal value of the wavelength may be considered, such that, for example, a wavelength range of 1525 nm to 1575 nm may be accepted around the nominal value of 1550 nm.

The second optical sensor has a second field of view. The second optical sensor operates in the visible wavelength range. The visible wavelength range is defined as from 380 nm to 780 nm.

The cover comprises at least a first glass sheet having an absorption coefficient less than 15 m⁻¹ at the operating wavelength range of the first optical sensor. The first glass sheet comprises an internal face facing the at least two different optical sensors and an external face opposite to the internal face.

To quantify the low absorption of the glass sheet in the near-infrared range, in the present description, the absorption coefficient is used in the wavelength range from 780 nm to 1650 nm. The absorption coefficient is defined by the ratio between the ab-sorbance and the optical path length traversed by electromagnetic radiation in a given environment. It is expressed in m⁻¹. It is therefore independent of the thickness of the material but it is function of the wavelength of the absorbed radiation and the chemical nature of the material.

In the case of glass, the absorption coefficient (u) at a chosen wavelength λcan be calculated from a measurement in transmission (T) as well as the refractive index n of the material (thick=thickness), the values of n, ρ and T being a function of the chosen wavelength λ:

$$μ = - \frac{1}{thick} \cdot ln [ \frac{- {( 1 - ρ )}^{2} + \sqrt{{( 1 - ρ )}^{4} + 4 \cdot {T}^{2} \cdot {ρ}^{2}}}{2 \cdot T \cdot {ρ}^{2}} ]$$

$$with ρ = {( n - 1 )}^{2} / {( n + 1 )}^{2} .$$

According to the present invention, the glass sheet having an absorption coefficient at the operating wavelength of near-infrared sensor of less than 15 m⁻¹, preferably less than 10 m⁻¹, even more preferably less than 5 m⁻¹, may be a soda-lime-silica glass, alumino-silicate, boro-silicate, . . .

Preferably, a glass composition compatible with the present invention comprises a total content expressed in weight percentages of glass:

| | |
|---|---|
| SiO₂ | 55-85% |
| Al₂O₃ | 0-30% |
| B₂O₃ | 0-20% |
| Na₂O | 0-25% |
| CaO | 0-20% |
| MgO | 0-15% |
| K₂O | 0-20% |
| BaO | 0-20%. |

More preferably, a glass composition compatible with the present invention comprises in a content expressed as total weight of glass percentages:

| | |
|---|---|
| SiO₂ | 55-78% |
| Al₂O₃ | 0-18% |
| B₂O₃ | 0-18% |
| Na₂O | 0-20% |
| CaO | 0-15% |
| MgO | 0-10% |
| K₂O | 0-10% |
| BaO | 0-5% |

More preferably, for reasons of lower production costs, the glass compatible with the present invention is made of soda-lime glass. A glass composition compatible with the present invention comprises a content expressed as the total weight of glass percentages:

| | |
|---|---|
| SiO₂ | 60-75% |
| Al₂O₃ | 0-6% |
| B₂O₃ | 0-4% |
| CaO | 0-15% |
| MgO | 0-10% |
| Na₂O | 5-20% |
| K₂O | 0-10% |
| BaO | 0-5%. |

In addition to its basic composition, the glass may include other components, nature and adapted according to quantity of the desired effect. A solution to obtain a very transparent glass in the near-infrared, with weak or no impact on its aesthetic or its color, is to combine in the glass composition a low iron quantity and optionally chromium in a range of specific contents. Thus, the glass preferably has a composition which comprises a content expressed as the total weight of glass percentages:

| | |
|---|---|
| Fe total (expressed asFe₂O₃) | 0.002-0.06% |
| Cr₂O₃ | 0-0.06%. |

Such glass compositions combining low levels of iron and chromium showed particularly good performance in terms of near-infrared reflection and show a high transparency in the visible and a little marked tint, near a glass called “extra-clear”. These compositions are described in international applications WO2014128016A1, WO2014180679A1, WO2015011040A1, WO2015011041A1, WO2015011042A1, WO2015011043A1 and WO2015011044A1.

The cover comprises a first zone corresponding at least to a projection of the first field of view on the cover. The cover also comprises a second zone, distinctive from the first zone, corresponding at least to a projection of the second field of view on the cover. The first zone is transparent at the operating wavelength range of the first optical sensor. Transparent in case of the operating wavelength range of the first optical sensor means a transmission of at least 85%. The second zone is transparent at the operating wavelength range of the second optical sensor. Transparent in case of the operating wavelength range of the second optical sensor means a transmission of at least 70%. Opaque in case of the operating wavelength range of the second optical sensor means a transmission of at maximum 10%.

According to a specific embodiment, the cover further comprises a second glass sheet, also having an absorption coefficient less than 15 m⁻¹ at the operating wavelength range of the first optical sensor. The second glass sheet comprises an internal face facing the at least two different optical sensors and an external face opposite to the internal face. The cover further comprises an interlayer laminating the internal face of the first glass sheet and the external face of the second glass sheet. The interlayer is transparent at the operating wavelength range of both the first and the second optical sensors.

According to a specific embodiment, an ink, transparent in the operating wavelength range of the first optical sensor and opaque in the operating wavelength range of the second optical sensor, is integrally applied on the internal face of the first glass sheet, except on the second zone of the cover. In case of the presence of a second glass sheet, the ink can either be integrally applied on the internal or the external face of the second glass sheet or on the interlayer laminating the first and the second glass sheets, in each case except on the second zone of the cover. In case the ink is applied on the interlayer, it can either be applied with a mask on the second zone of the cover, therefore leading to ink not present in the second zone of the cover. Otherwise, the ink may be applied integrally on the interlayer, and a part of the interlayer corresponding to the second zone may be cut off and replaced by an insert, the insert being transparent in the operating wavelength range of the second optical sensor.

According to a specific embodiment, a film, transparent in the operating wavelength range of the first optical sensor and opaque in the operating wavelength range of the second optical sensor, is integrally applied on the internal face of the first glass sheet, except on the second zone of the cover. In case of the presence of a second glass sheet, the film can be integrally applied on the internal or the external face of the second glass sheet or on the interlayer laminating the first and the second glass sheets, in each case except on the second zone of the cover.

According to a specific embodiment, the cover further comprises a second glass sheet having an absorption coefficient less than 15 m⁻¹ at the operating wavelength range of the first optical sensor. The second glass sheet comprises an internal face facing the at least two different optical sensors and an external face opposite to the internal face. The cover further comprises an interlayer laminating the internal face of the first glass sheet and the external face of the second glass sheet. The interlayer is transparent at the operating wavelength range of the first optical sensor. The interlayer is replaced by an insert in the second zone, the insert being transparent in the operating wavelength range of the second optical sensor.

According to a specific embodiment, the cover further comprises a second glass sheet having an absorption coefficient less than 15 m⁻¹ at the operating wavelength range of the first optical sensor. The second glass sheet comprises an internal face facing the at least two different optical sensors and an external face opposite to the internal face. The cover further comprises a film, transparent in the operating wavelength range of the first optical sensor and opaque in the operating wavelength range of the second optical sensor, replaced by an insert in the second zone, the insert being transparent in the operating wavelength range of the second optical sensor. The cover further comprises a first interlayer laminating the internal face of the first glass sheet and the film, and a second interlayer laminating the external face of the second glass sheet and the film, both the first and the second interlayers being transparent at the operating wavelength range of both the first and the second optical sensors.

According to a specific embodiment, the cover further comprises a second glass sheet having an absorption coefficient less than 15 m⁻¹ at the operating wavelength range of the first optical sensor. The second glass sheet comprises an internal face facing the at least two different optical sensors and an external face opposite to the internal face. The cover further comprises a film, the film being transparent in the operating wavelength range of the first and second optical sensors. The film is covered by an ink except in the second zone of the cover. The ink is transparent in the operating wavelength range of the first optical sensor and opaque in the operating wavelength range of the second optical sensor. The cover further comprises a first interlayer laminating the internal face of the first glass sheet and the film, and a second interlayer laminating the external face of the second glass sheet and the film, both the first and the second interlayers being transparent at the operating wavelength range of both the first and the second optical sensors.

In a specific embodiment, the first optical sensor is a lidar or a near-infrared camera.

In a specific embodiment, the second optical sensor is a camera.

In a specific embodiment the first glass sheet, and in case of the presence of a second glass sheet, the second glass sheet too, have an absorption coefficient of less than 10 m⁻¹, more preferably less than 5 m⁻¹, in the operating wavelength range of the second optical sensor.

In a specific embodiment, the internal face and/or the external face of the first glass sheet and/or the internal face of the second glass sheet (in case of the presence of a second glass sheet) is coated with an antireflection coating. Such antireflection coating allows to decrease reflection, and therefore to increase the signal sent and/or received to/from the near-infrared sensor. As an example, an antireflection coating may be a layer based on porous silica having a low refractive index or it may be composed of several layers (stack), in particular a stack of layers of dielectric material alternating layers having low and high refractive indexes and terminating in a layer having a low refractive index. A textured glass sheet may be also used. Etching or coating techniques may as well be used in order to avoid reflection. Preferably, the reflection of the treated surface would decrease from at least 1% and preferably from at least 2% if both surfaces are coated, within the concerned wavelength range. The antireflection layer may be a layer based on refractive index gradient layer deposited for example by ion implantation technique.

In a specific embodiment, the external face of the first glass sheet is coated with a water repellent coating. The glass cover may be coated with a hydrophobic layer that prevents water droplets to aggregate onto the glass cover. Such coating allows to ensure proper sensor operation in case of rain (snow, frost) and/or in case of fog. Such water repellant coating can be, for example, composed of thin molecular layers of fluoropolymers that reduces the surface energy and provides self-cleanabil-ity, anti-stain properties and improved moisture resistance among other effects.

Other suitable advantageous functionalities can be added to the glass sheet of the cover of the invention, in particular to provide supporting functions to further en-hance the good operation of the near-infrared sensor. Those supporting functions can be for example: the coupling with integrated detection functions for breakage, dirt, stain, min, . . . or additional protection layers for preventing scratches, glare, stain, dirt, paint, . . . Dedicated filters could also be integrated for polarization, phase or spectral discrimination.

In a specific embodiment, the cover further comprises a silverprint or a conductive coating. The cover may be coupled with a heating system that allows the cover to quickly defrost or defog when the external operating conditions are unfavorable. Such heating system can be composed of a network of conductive wires, conductive patch or alternatively a silverprint network directly applied on the glass surface where an adequate power supply can be applied. Optionally, the system can also comprise a temperature sensor for dynamically triggering the heating function in case of need.

In a specific embodiment, the cover is a part of a windshield, a backlite, a sidelite or an exterior trim element of a vehicle. An exterior trim element includes bumper, window/door seal, pillar, wheel well, wheel arch, fender, headlight, mirror body and roof cover. Such exterior trim element can also be deployable, meaning it can pop out from the vehicle only when needed. Vehicle manufacturers use these exterior trim elements to add aesthetics, increase function, and add flexibility to the vehicle design.

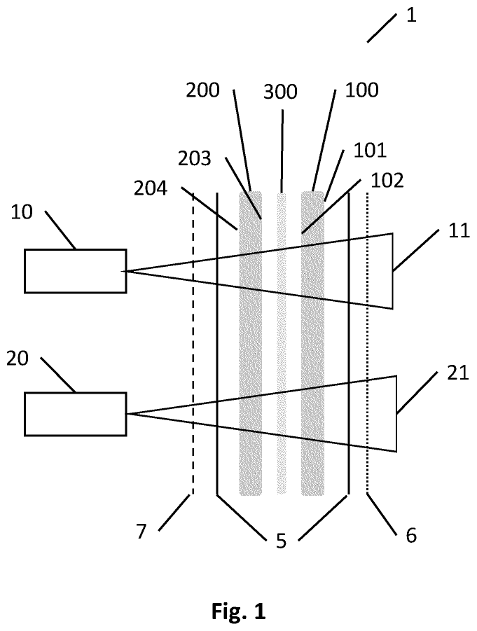

Referring to FIG. 1, a cover (1) is shown in front of a first optical sensor (10) having a first field of view (11) and a second optical sensor (20) having a second filed of view (21). The cover comprises a first glass sheet (100), with an internal face (102) facing the sensors (10, 20) and an external face (101) opposite to the internal face (102). The cover further comprises a second glass sheet (200), with an internal face (204) facing the sensors (10, 20) and an external face (203) opposite to the internal face (204). The first and second glass sheets (100, 200) are laminated together by an interlayer (300). The cover (1) in this figure is therefore a laminated cover (1), meaning a cover (1) made of at least two glass sheets (100, 200) laminated together by an interlayer (300).

A first zone can be defined on the cover (1), corresponding to the projection on the cover (1) of the first field of view (11), as well as a second zone corresponding to the projection on the cover (1) of the second field of view (21).

FIG. 1 further shows an optional antireflective coating positioned on the external face (104) of the first glass sheet (100) and/or on the internal face (204) of the second glass sheet (200). FIG. 1 also shows an optional water repellent coating positioned on the external face (104) of the first glass sheet (100). FIG. 1 also shows an optional heating coating or a silverprint positioned on the internal face (204) of the second glass sheet (200). All of these optional elements can be applied to the various following embodiments, but have not been represented in order not to complexify the drawings. Besides, all the examples show the case of a laminated cover, but the invention can be practiced on a monolithic cover made of a single glass sheet, or on a cover comprising more than two glass sheets.

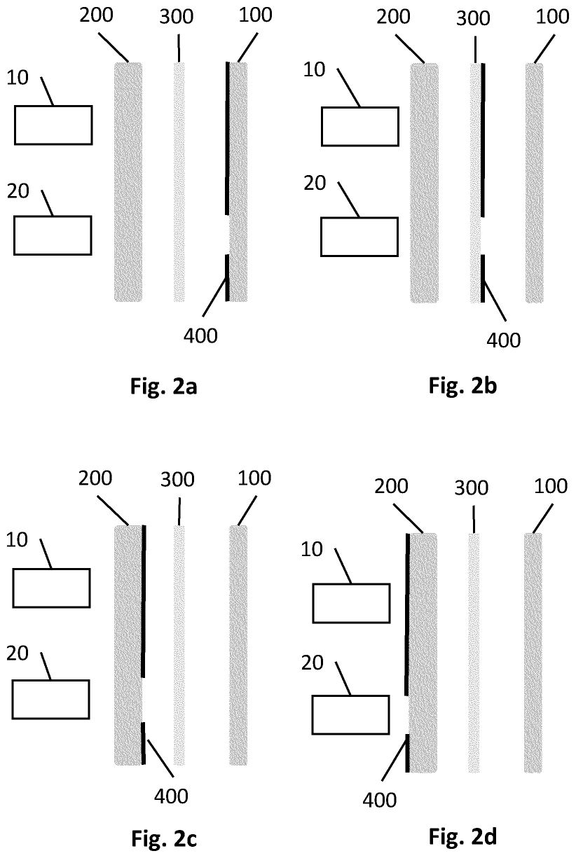

FIG. 2a-d represent various alternatives of an ink (400) deposited either:
a on the internal face (102) of the first glass sheet (100);
b on the interlayer (300);
c on the external face (203) of the second glass sheet (200);
d on the internal face (204) of the second glass sheet (200).
   The ink (400) is transparent in the operating wavelength range of the first optical sensor (10) and opaque in the operating wavelength range of the second optical sensor (20). The ink (400) can be deposited by screenprinting technique or any other techniques known by the skilled in the art. In order not to deposit the ink (400) in the second zone of the cover (1), usually a mask is applied during the application of the ink (400), leading to the absence of ink (400) in the zone covered by the mask.

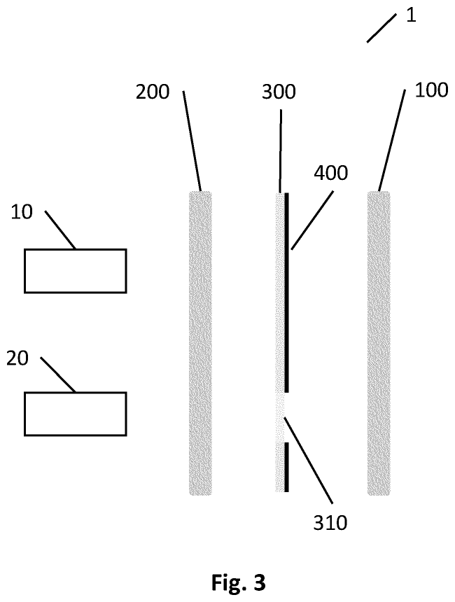

FIG. 3 represents an alternative to the product shown on FIG. 2b. Instead of using the masking technique as described previously, the interlayer (300) can be fully printed with the ink (400). Before laminating the two glass sheets (100, 200) with the interlayer (300), some part of the interlayer (300) is cut out and replaced by an insert (310) corresponding to the second zone of the cover (1). The insert is transparent in the operating wavelength range of the second optical sensor (20). It allows better optical quality in the second field of view.

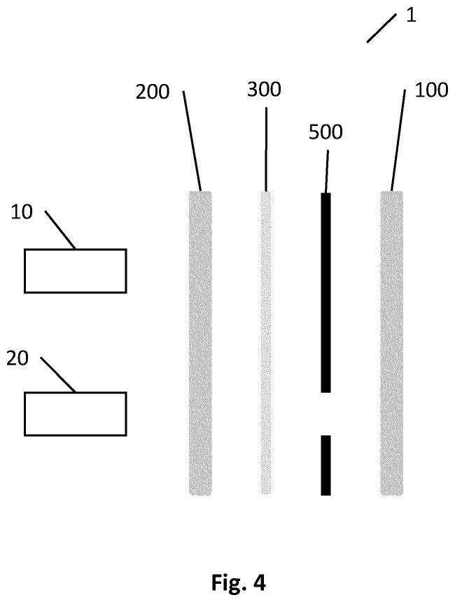

FIG. 4 shows an embodiment wherein a film (500) is positioned between the first glass sheet (100) and the interlayer (300). Such product also allows better optical quality in the second field of view.

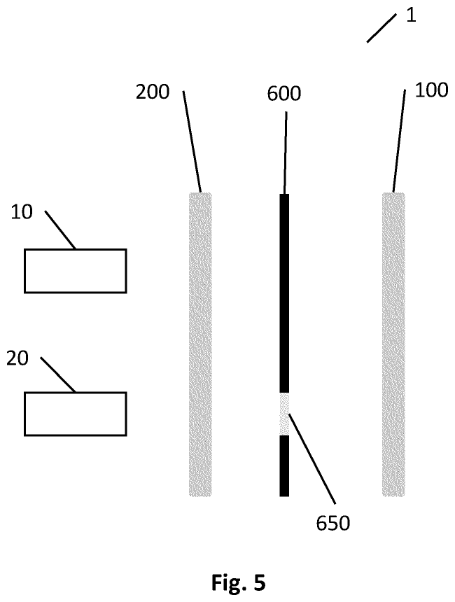

FIG. 5 represents an embodiment wherein an interlayer (600) which is transparent at the operating wavelength range of the first optical sensor (10) and opaque at the operating wavelength range of the second optical sensor (20) is placed between the first and second glass sheets (100, 200). Before laminating the two glass sheets (100, 200) with the interlayer (600), some part of the interlayer (600) is cut out and replaced by an insert (650) corresponding to the second zone of the cover (1). The insert is transparent in the operating wavelength range of the second optical sensor (20). Such cover (1) allows better optical quality in the second field of view.

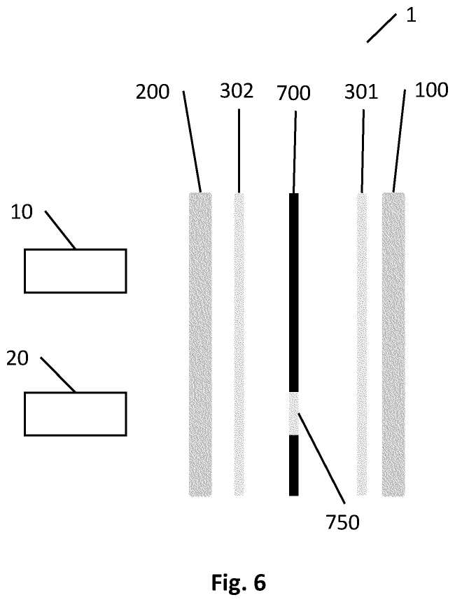

FIG. 6 shows an embodiment wherein a film (700) which is transparent at the operating wavelength range of the first optical sensor (10) and opaque at the operating wavelength range of the second optical sensor (20) is placed between a first and a second interlayers (301, 302), themselves placed between a first and a second glass sheets (100, 200). Some part of the film (700) is cut out and replaced by an insert (750) corresponding to the second zone of the cover (1). The insert is transparent in the operating wavelength range of the second optical sensor (20).

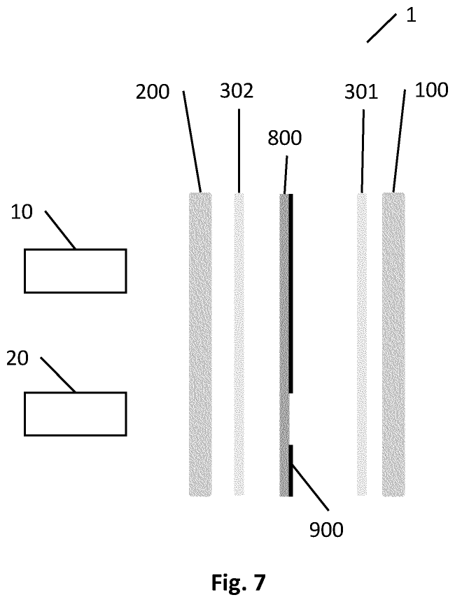

FIG. 7 shows an embodiment wherein a film (800) which is transparent at the operating wavelength range of the first and the second optical sensors (10, 20) is placed between a first and a second interlayers (301, 302), themselves placed between a first and a second glass sheets (100, 200). The film (800) is printed with an ink (900), except on the second zone of the cover (1). The ink (900) is transparent at the operating wavelength range of the first optical sensor (10) and opaque at the operating wavelength range of the second optical sensor (20).

While the invention has been illustrated and described in detail in the drawings and foregoing description, such illustration and description are to be considered illustrative or exemplary and not restrictive. The foregoing description details certain embodiments of the invention. It will be appreciated, however, that no matter how detailed the foregoing appears in text, the invention may be practiced in many ways. The invention is not limited to the disclosed embodiments.

1: A cover for a vehicle sensor module, wherein the vehicle sensor module comprises at least two different optical sensors, wherein a first optical sensor having a first field of view operates in a near-infrared wavelength range, and a second optical sensor having a second field of view operates in a visible wavelength range, the cover comprising at least a first glass sheet having an absorption coefficient less than 15 m⁻¹ at the operating wavelength range of the first optical sensor, the at least first glass sheet, comprising an internal face destined to face the at least two different optical sensors and an external face opposite to the internal face, the cover, comprising:
i. a first zone destined to correspond to at least a projection of the first field of view on the cover; and
ii. a second zone, distinctive from the first zone, destined to correspond to at least a projection of the second field of view on the cover,
wherein the first zone is transparent at the operating wavelength range of the first optical sensor and the second zone is transparent at the operating wavelength range of the second optical sensor.

2: The cover according to claim 1, wherein the cover further comprises:
i. a second glass sheet having an absorption coefficient less than 15 m⁻¹ at the operating wavelength range of the first optical sensor, the second glass sheet comprising an internal face destined to face the at least two different optical sensors and an external face opposite to the internal face; and
ii. an interlayer laminating the internal face of the first glass sheet and the external face of the second glass sheet, the interlayer being transparent at the operating wavelength range of both the first and the second optical sensors.

3: The cover according to claim 2, wherein an ink, transparent in the operating wavelength range of the first optical sensor and opaque in the operating wavelength range of the second optical sensor, is integrally applied on the internal face of the first glass sheet or on the internal face or the external face of the second glass sheet or on the interlayer except on the second zone of the cover.

4: The cover according to claim 3, wherein the interlayer is replaced by an insert in the second zone, the insert being transparent in the operating wavelength range of the second optical sensor.

5: The cover according to claim 2, wherein a film, transparent in the operating wavelength range of the first optical sensor and opaque in the operating wavelength range of the second optical sensor, is integrally applied on the internal face of the first glass sheet or on the internal face or the external face of the second glass sheet or on the interlayer except on the second zone of the cover.

6: The cover according to claim 1, wherein the cover further comprises:
iii. a second glass sheet having an absorption coefficient less than 15 m⁻¹ at the operating wavelength range of the first optical sensor, the second glass sheet comprising an internal face destined to face the at least two different optical sensors and an external face opposite to the internal face; and
iv. an interlayer laminating the internal face of the first glass sheet and the external face of the second glass sheet, the interlayer being transparent at the operating wavelength range of the first optical sensor, wherein the interlayer is replaced by an insert in the second zone, the insert being transparent in the operating wavelength range of the second optical sensor.

7: The cover according to claim 1, wherein the cover further comprises:
i. a second glass sheet having an absorption coefficient less than 15 m⁻¹ at the operating wavelength range of the first optical sensor, the second glass sheet comprising an internal face destined to face the at least two different optical sensors and an external face opposite to the internal face;
ii. a film, transparent in the operating wavelength range of the first optical sensor and opaque in the operating wavelength range of the second optical sensor, the film being replaced by an insert in the second zone, the insert being transparent in the operating wavelength range of the second optical sensor;
iii. a first interlayer laminating the internal face of the first glass sheet and the film, the first interlayer being transparent at the operating wavelength range of both the first and the second optical sensors; and
iv. a second interlayer laminating the external face of the second glass sheet and the film, the second interlayer being transparent at the operating wavelength range of both the first and the second optical sensors.

8: The cover according to claim 1, wherein the cover further comprises:
i. a second glass sheet having an absorption coefficient less than 15 m⁻¹ at the operating wavelength range of the first optical sensor, the second glass sheet comprising an internal face destined to face the at least two different optical sensors and an external face opposite to the internal face;
ii. a film, transparent in the operating wavelength range of the first and second optical sensors, the film being covered by an ink except in the second zone of the cover, the ink being transparent in the operating wavelength range of the first optical sensor and opaque in the operating wavelength range of the second optical sensor;
iii. a first interlayer laminating the internal face of the first glass sheet and the film, the first interlayer being transparent at the operating wavelength range of both the first and the second optical sensors; and
iv. a second interlayer laminating the external face of the second glass sheet and the film, the second interlayer being transparent at the operating wavelength range of both the first and the second optical sensors.

9: The cover according to claim 1, wherein the first optical sensor is a lidar or a near-infrared camera.

10: The cover according to claim 1, wherein the second optical sensor is a camera.

11: The cover according to claim 6, wherein the first and second glass sheets have an absorption coefficient of less than 10 m⁻¹, in the operating wavelength range of the second optical sensor.

12: The cover according to claim 6, wherein the external face of the first glass sheet and/or the internal face of the second glass sheet is coated with an antireflection coating.

13: The cover according to claim 1, wherein the external face of the first glass sheet is coated with a water repellent coating.

14: The cover according to claim 1, wherein the cover further comprises a silverprint or a conductive coating.

15: The cover according to claim 1, wherein the cover is a part of a windshield, a backlite, a sidelite or an exterior trim element of a vehicle.

16: The cover according to claim 6, wherein the first and second glass sheets have an absorption coefficient less than 5 m⁻¹ in the operating wavelength range of the second optical sensor.
